(19) United States
(12) Patent Application Publication
(10) Pub. No.: US 2002/0045694 A1
(43) Pub. Date: Apr. 18, 2002

(54) Novel hydrogen-absorbing composition, process for its preparation and use as composition for filling optical fibre cables

(76) Inventor: Gerard Trouve, Castres (FR)

Correspondence Address: YOUNG & THOMPSON, 745 SOUTH 23RD STREET 2ND FLOOR, ARLINGTON, VA, 22202

(21) Appl. No.: 09/897,880

(22) Filed: Jul. 5, 2001

(30) Foreign Application Priority Data
Jul. 5, 2000 (FR) 000 8762

(51) Int. Cl. C08K 5/04; C08K 3/34

(52) U.S. Cl. 524/394; 524/492

(57) ABSTRACT

Composition, characterized in that it comprises a hydrocarbonaceous compound or a mixture of hydrocarbonaceous compounds, a nonzero proportion of one or more transition metals and a nonzero proportion of at least one slightly polar dispersing liquid fatty phase, having one or more hydrocarbonaceous chains, with an HLB of between 0.5 and 9, preferably between 4 and 9. Its process of preparation and its use as composition for filling optical fiber cables.

A subject-matter of the invention is novel hydrogen-absorbing compositions comprising dispersing agents and their use in the manufacture of optical fiber cables.

Optical fibers, which make possible the transmission of increasingly large amounts of information, are laid in cables liable to be subjected to significant mechanical and chemical stresses, in particular when they are submarine cables. To restrict the effects of these stresses, the fibers are protected by metal or plastic sheathings and are “immersed” in greases which contribute to cushioning the impacts and to restricting the microcurves which result therefrom and which interfere with the transmission of the signals. These microcurves are also caused by the appearance of hydrogen microbubbles which form inside the grease at the time of the manufacture of the cable, during welding operations or over time as an effect of ageing. This is why some greases currently sold comprise compounds which absorb hydrogen.

Thus, the French patent application published under the number 2 607 311 discloses a hydrophobic thixotropic composition intended for the manufacture of optical fiber cables comprising 100 parts by weight of a lubricating fluid composed of 30% to 100% by weight of polybutene, preferably hydrogenated polybutene, having a number-average molecular mass of between 280 and 800 and of 0% to 70% by weight of at least one liquid lubricant chosen from mineral oils, synthetic oils and silicones and 7 to 20 parts by weight of a hydrophobic thixotropic agent chosen from a hydrophobic silica and a hydrophobic bentonite. The use of a polar agent, such as propylene carbonate, for improving the dispersion of the silicas or bentonites is disclosed in the patent application. The British patent application published under the number 2 144 559 discloses hydrogen-absorbing compositions for optical fiber cables which comprise polybutene, aromatic hydrocarbons, palladium or active charcoal. The United States patent published under the number U.S. Pat. No. 4,668,889 discloses hydrogen-absorbing compositions for the filling of optical fiber cables which comprise the mixture of an unsaturated silicone with a catalyst chosen from transition metals, organic salts of transition metals or organometallic compounds of the said metals and more specifically palladium powder, platinum powder, nickel powder, iron pentacarbonyl or chloroplatinic acid, the said metals optionally being supported on inert compounds, such as animal or vegetable carbon black. The United States patent published under the number U.S. Pat. No. 4,741,592 discloses hydrogen-absorbing compositions for the filling of optical fiber cables which comprise the mixture of an unsaturated polymer obtained by the polymerization of conjugated dienes with a catalyst chosen from transition metals, organic salts of transition metals or organometallic compounds of the said metals and more specifically palladium powder, platinum powder, nickel powder, iron pentacarbonyl or copper chromite, the said metals optionally being supported on inert compounds, such as animal or vegetable carbon black. The European patent application published under the number EP 0 632 301 discloses hydrogen-absorbing compositions for the filling of optical fiber cables which comprise the mixture of an unsaturated hydrocarbonaceous compound, for example polybutene or propylene-ethylene, propylene-butene and propylene-hexene copolymers, the propylene-butene-ethylene terpolymer, glyceryl ricinoleate or resin oil, with a catalyst chosen from transition metals, organic salts of transition metals or organometallic compounds of the said metals and more specifically palladium powder, platinum powder, nickel powder or iron pentacarbonyl, the said metals optionally being supported on inert compounds. The French patent application published under the number 2 763 955 discloses a composition for filling optical fiber cables which comprises from 75% to 95% by weight of a propoxylated bisphenol with a molecular weight of less than 3 000, from 5% to 25% by weight of a thixotropic agent and from 0.1% to 1% by weight of an antioxidizing agent.

The palladium-based compounds are provided in the form of very fine powders with a diameter of approximately ten microns and with a high specific surface area. In point of fact, these powders are difficult to disperse homogeneously and have a tendency to form agglomerates in the greases, which reduces the overall specific surface area of the catalyst and thus the effectiveness of the grease in absorbing hydrogen. On the other hand, at equal effectiveness, a good dispersion of the catalyst in the grease makes it possible to use smaller amounts of catalyst and thus to decrease the cost price of these greases. This is why the Applicant Company has sought to develop novel compositions in which the catalyst powders are dispersed more homogeneously than in those of the state of the art.

A subject-matter of the invention is a composition, characterized in that it comprises a hydrocarbonaceous and/or silicone compound or a mixture of hydrocarbonaceous and/or silicone compounds, a nonzero proportion of one or more transition metals and a nonzero proportion of at least one slightly polar dispersing liquid fatty phase, having one or more hydrocarbonaceous chains, with an HLB of between 0.5 and 9, preferably between 4 and 9.

The term “hydrocarbonaceous and/or silicone compound or mixture of hydrocarbonaceous and/or silicone compounds” denotes in particular hydrocarbons, hydrocarbonaceous polymers, silicone oils and/or polyol derivatives.

The composition which is a subject-matter of the present invention generally comprises from 50% to 90% by weight of hydrocarbonaceous and/or silicone compound or of mixture of hydrocarbonaceous and/or silicone compounds.

Hydrocarbons or hydrocarbonaceous polymers include, for example, poly-alpha-olefins (PAO) or copolymers of alpha-olefins comprising from 8 to 12 carbon atoms, polyisobutene (PIB) or polybutene, obtained by polymerization of isobutene, of 1-butene and/or of 2-butene, propylene-ethylene, propylene-butene and propylene-hexene copolymers, propylene-butene-ethylene terpolymers or polybutadienes. The silicone oils can be chosen from poly(alkylsiloxanes), in particular poly(dimethylsiloxanes), with high molecular weights having a viscosity of the order of 10 000 to 30 000 cSt at ambient temperature. The polyol derivatives are obtained by etherification or esterification of a compound having several hydroxyl functional groups, such as, for example, glycerol, TMP or bisphenol, by means of hydrocarbonaceous fatty chains or alkoxide chains, such as polyethylene glycol, polypropylene glycol or polybutylene glycol.

The composition which is a subject-matter of the present invention also comprises one or more metal catalysts in a proportion by weight ranging up to 5% by weight of the said composition. Examples of metal compounds appropriate to the present invention include, for example, transition metals, organic salts of transition metals or organometallic compounds of the said metals and more specifically palladium powder, platinum powder, nickel powder, iron pentacarbonyl, chloroplatinic acid, copper chromite, Raney nickel, palladium supported on active charcoal, palladium supported on alumina, platinum supported on alumina or platinum supported on active charcoal.

According to a specific alternative form of the present invention, the composition comprises up to 1% by weight of palladium supported on alumina or on active charcoal.

The composition which is a subject-matter of the present invention also comprises up to 15% by weight of silica. Hydrophobic treated silica, such as, for example, Aerosil™ R974, can be used but the preferred silica is hydrophilic silica, for example hydrophilic pyrogenic silica, such as that sold under the name of Aerosil™ 200, or hydrophilic colloidal silica, such as that sold under the name of Cab-O-Sil™ TS 720.

The composition which is a subject-matter of the present invention optionally comprises up to approximately 5% of a viscosifying polymer. Examples of viscosifying polymer include styrene, ethylene, propylene, butylene or butadiene polymers or diblock copolymers of these monomers, such as polystyrene-polyethylene, 8 polystyrene-[polyethylene+polypropylene], polystyrene-polyisoprene or polystyrene-polybutene, or triblock polymers, such as polystyrene-polyethylene-polystyrene, polystyrene-[polyethylene+polypropylene]-polystyrene, polystyrene-polyisoprene-polystyrene or polystyrene-polybutadiene-polystyrene. Polymers of this type are sold under the trade names Kraton™ G or Kraton D, Septon™ or Shellvis™.

The composition which is a subject-matter of the present invention optionally comprises up to approximately 2% of an antioxidizing agent chosen, for example, from compounds with a sterically hindered phenolic structure, such as polymeric 2,2,4-trimethyl-1,2-dihydroquinoline, phenothiazine, octyl (3,5-di-tert-butyl-4-hydroxyphenyl)propionate, hydroquinone monomethyl ether or triethylene glycol bis [3-(3′-tert-butyl-4′-hydroxy-5′-methylphenyl)propionate], sold under the name of Irganox™ 245, or ethylenebis-(oxyethylene) bis(3-tert-butyl-4-hydroxy-5-methylhydrocinnamate), Irganox™ 1076, or Irganox™ 1010.

The term “slightly polar dispersing liquid fatty phase having one or more hydrocarbonaceous chains, with an HLB of between 0.5 and 9, preferably between 4 and 9” is preferably understood to mean fatty phases which are liquid at ambient temperature.

The HLB number, or hydrophilic-lipophilic balance, and its method of determination are known to a person skilled in the art. This parameter makes it possible to assess the hydrophobic and hydrophilic natures of a given surface-active agent. In the context of the present invention, for surface-active agents comprising an ester functional group, it is determined by the following formula:

HLB=20×[1−(SN/AN)],

in which SN represents the saponification number of the product, measured according to NFT Standard 60206, and AN represents the acid number of the precursor acids, measured according to NFT Standard 60204.

In the case of surface-active agents comprising an ether functional group, the HLB is calculated by the equation:

HLB=20×(Mₕ/M)

in which Mₕ is the mass of the hydrophilic part of the molecule and M is its overall molecular mass.

The composition which is a subject-matter of the present invention comprises from 1% to 20% and preferably between 5% and 10% by weight of dispersing fatty phase.

According to another specific aspect of the present invention, the ratio by weight of the metal catalyst or catalysts to the dispersing fatty phase in the composition is between approximately 0.01 and 0.20.

Slightly polar dispersing fatty phase appropriate to the present invention includes vegetable oils, such as, for example, sunflower oil, rapeseed oil, maize oil, soybean oil, castor oil, linseed oil, coconut oil, groundnut oil, olive oil, palm oil or hydrogenated palm oil, or modified vegetable oils, such as methyl esters of vegetable oils, monoglycerides or diglycerides obtained by controlled hydrolysis of vegetable oils, weakly alkoxylated vegetable oils, in particular weakly ethoxylated and/or propoxylated vegetable oils, more particularly ethoxylated vegetable oils comprising from 1 to 10 ethylene oxide units, or weakly alkoxylated methyl esters of vegetable oils, in particular weakly ethoxylated and/or propoxylated methyl esters of vegetable oils and more particularly methyl esters of vegetable oils ethoxylated with 1 to 4 ethylene oxides. The preparation of these modified vegetable oils is disclosed in the international patent applications published under the numbers WO 96/22109 and WO 00/01233.

The term “weakly alkoxylated” indicates, in the preceding and in the following, that the alkoxylation number and in particular the ethoxylation and propoxylation numbers, which represent respectively the number of ethoxyl units (EO number) and the number of propoxyl units (PO number) per molecule, is less than or equal to approximately 15[EO number=15 or PO number=15 or (EO number+PO number)=approximately 15].

Other slightly polar liquid dispersing fatty phase appropriate to the present invention includes surface-active agents having an HLB number of between 1 and 9, preferably between 4 and 9, which are miscible with the oils which participate in the composition of the greases. Examples include linear or branched fatty alcohols or fatty acids comprising from 5 to 30 carbon atoms and more particularly from 12 to 22 carbon atoms or the esters of the said acids, the said alcohols, acids or esters optionally being weakly alkoxylated. Preference is given, among these, to surface-active agents which are liquid at ambient temperature, such as those comprising an oleyl, oleyl/cetyl, linoleyl or behenyl chain. These compounds are optionally weakly alkoxylated. Examples of surface-active agents of this nature include sorbitan oleic esters, oleyl alcohols comprising from 1 to 5 ethylene oxide units (EO=5), polyethylene glycol (PEG) oleates comprising from 1 to 5 ethylene oxide units (1≦EO≦5), liquid glucose ethers or oleic acid comprising from 1 to 5 ethylene oxide units.

According to another aspect of the present invention, a subject-matter of the latter is a process for producing the composition as defined above comprising a stage of dispersing the catalyst in the dispersing agent as defined above, followed by mixing the dispersion in the other constituents of the composition which is a subject-matter of the present invention.

The process as defined above is a preferred route but it is possible to mix the dispersing phase with the oils of the grease, to add the palladium powder and then to add the other components.

According to a final aspect of the present invention, a subject-matter of the latter is the use of the composition as defined above as composition for filling optical fiber cables.

The following examples illustrate the invention without, however, limiting it.

### A) Demonstration of the Influence of the Dispersing Fatty Phase on the Amount of Hydrogen Absorbed by the Composition

The examples in Tables 1a to 1e are obtained from a model grease composed of:

5 or 10% by weight of a dispersing fatty phase (referred to as DFP)

3.8% by weight of a viscosifying polymer (Shellvis™ 40),

6.5% by weight of hydrophilic silica (Cab-O-Sil™ TS 720),

0.4% of an antioxidant (Irganox™ 1076),

0.6% of palladium supported on alumina catalyst,

q.s. for 100% of poly-alpha-olefin (PAO).

The measured characteristics of the compositions are as follows:

the volatility, after residence in an oven at 150° C. for 24 h,

the release of oil (exsudation), after residence in an oven at 150° C. for 24 hours,

the viscosity at a high shear gradient (approximately 2500 Pa·s), measured on a Carrimed viscometer with a cone with a diameter of 2 cm and an angle of 2°,

the hydrogen absorption per gram of grease at 24 hours and at 48 hours, in a cell under an initial hydrogen pressure of 400 mm of mercury at ambient temperature.

The results reveal that all the greases formulated with 5 to 10% of a polar fatty phase have viscosities, exsudations and volatilities close to those of the control formula but that the hydrogen absorption is, on the other hand, markedly improved, in particular when the dispersing fatty phase has an HLB number in the region of 4 or greater than 4. Additives not possessing a long hydrocarbonaceous fatty chain, such as oxypropylated bisphenol A (comparative example), give results which are only slightly better than those of the control.

TABLE 1a

| Examples | | Control | Ex. 1 |
|---|---|---|---|
| DFP | | None | Methyl ester of |
| (nature; amount as %; | | | rapeseed oil; |
| HLB) | | | 5% |
| | | | HLB = 0.5 |
| Volatility | | 1.17% | 4.16% |
| Exsudation | | 0% | 0% |
| Plastic viscosity | | 0.90 Pa · s at | 0.78 Pa · s at |
| | | 2534 Pa | 2445 Pa |
| H₂ pressure | at T = 0 h | 405 mmHg (0) | 401 mmHg (0) |
| in mmHg, | at T = 24 h | 322 mmHg (1.08) | 204 mmHg (3.27) |
| H₂ absorption | at T = 48 h | 321 mmHg (1.39) | 174 mmHg (3.76) |
| in ml/g | | | |

TABLE 1b

| Examples | | Ex. 2 | Ex. 3 |
|---|---|---|---|
| DFP | | Ethoxylated (2 | Rapeseed oil; |
| (nature; amount as %; | | EO) oleyl/cetyl | 5%; HLB = 0.5 |
| HLB) | | alcohol; 5%; | |
| | | HLB = 6 | |
| Volatility | | 2.67% | 1.81% |
| Exsudation | | 0% | 0% |
| Plastic viscosity | | 0.81 Pa · s at | 0.83 Pa · s at |
| | | 2093 Pa | 2394 Pa |
| H₂ pressure | at T = 0 h | 406 mmHg (0) | 400 mmHg |
| in mmHg, | at T = 24 h | 277 mmHg (2.14) | 304 mmHg (1.59) |
| H₂ absorption | at T = 48 h | 246 mmHg (2.65) | 277 mmHg (2.04) |
| in ml/g | | | |

TABLE 1c

| Examples | | Ex. 4 | Ex. 5 |
|---|---|---|---|
| DFP | | Ethoxylated (4 | Alkoxylated (5 |
| (nature; amount as %; | | EO) maize oil; | EO 4 PO 5 EO) |
| HLB) | | 5%; HLB = 5 | oleic acid; 5%; |
| | | | HLB = 3 |
| Volatility | | 1.6% | 2.01% |
| Exsudation | | 0% | 0% |
| Plastic viscosity | | 0.90 Pa · s at | 0.88 Pa · s at |
| | | 2125 Pa | 2494 Pa |
| H₂ pressure | at T = 0 h | 400 mmHg | 405 mmHg |
| in mmHg, | at T = 24 h | 304 mmHg (1.7) | 299 mmHg (1.76) |
| H₂ absorption | at T = 48 h | 277 mmHg (2.24) | 291 mmHg (1.89) |
| in ml/g | | | |

TABLE 1d

| Examples | | Ex. 6 | Comparative |
|---|---|---|---|
| DFP | | Ethoxylated (5 | Oxypropylated |
| (nature; amount as %; | | EO) oleic acid; | bisphenol A |
| HLB) | | 5%; HLB = 8.7 | 10%; HLB = 1 |
| Volatility | | 1.43% | 1.71% |
| Exsudation | | 0% | 0.06% |
| Plastic viscosity | | 0.90 Pa · s at | 0.91 Pa · s at |
| | | 2344 Pa | 2394 Pa |
| H₂ pressure | at T = 0 h | 402 mmHg | 403 mmHg |
| in mmHg, | at T = 24 h | 279 mmHg (2.03) | 315 mmHg (1.45) |
| H₂ absorption | at T = 48 h | 249 mmHg (2.53) | 309 mmHg (1.55) |
| in ml/g | | | |

TABLE 1e

| Examples | | Ex. 7 | Ex. 8 |
|---|---|---|---|
| DFP | | Sorbitan | Ethoxylated (10 |
| (nature; amount as %; | | oleate; 10%; | EO) oleic acid; |
| HLB) | | HLB = 4.3 | HLB = 8.7 |
| Volatility | | 2.22% | 2.0% |
| Exsudation | | 1.94% | 0% |
| Plastic viscosity | | 0.85 Pa · s at | 0.89 Pa · s |
| | | 1994 Pa | |
| H₂ pressure | at T = 0 h | 403 mmHg | 401 mmHg |
| in mmHg, | at T = 24 h | 284 mmHg (1.97) | 255 mmHg (2.4) |
| H₂ absorption | at T = 48 h | 249 mmHg (2.54) | 221 mmHg (2.97) |
| in ml/g | | | |

### B) Demonstration of the Influence of the Catalyst/Dispersing Fatty Phase Ratio by Weight on the Amount of Hydrogen Absorbed by the Composition

The examples in Tables 2a to 2c are obtained from a model grease composed of:

5% by weight of ethoxylated (5 EO) oleic acid with an HLB of 8.7,

3.8% by weight of a viscosifying polymer (Shellvis™ 40),

6.5% by weight of hydrophilic silica (Cab-O-Sil™ TS720),

0% to 0.6% of palladium supported on alumina catalyst,

q.s. for 100% of poly-alpha-olefin (PAO).

In all cases, the amounts of hydrogen absorbed in 48 h are greater than those absorbed by the control not comprising dispersing phase while comprising 0.6% of catalyst.

TABLE 2a

| Examples | | Control | Ex. 9 |
|---|---|---|---|
| Catalyst/DFP ratio by | | 0 | 0.04 |
| weight | | | |
| Catalyst (% by weight) | | 0% | Pd/Al₂O₃; 0.20% |
| Volatility | | 1.3% | 1.3% |
| Exsudation | | 0% | 0% |
| Plastic viscosity | | 0.90 Pa · s at | 0.90 Pa · s at |
| | | 2344 Pa | 2344 Pa |
| H₂ pressure | at T = 0 h | 403 mmHg (0) | 402 mmHg (0) |
| in mmHg, | | | |
| H₂ absorption | at T = 48 h | 402 mmHg (0) | 295 mmHg (1.78) |
| in ml/g | | | |

TABLE 2b

| Examples | | Ex. 10 | Ex. 11 |
|---|---|---|---|
| Catalyst/DFP ratio by | | 0.08 | 0.12 |
| weight | | | |
| Catalyst (% by weight) | | Pd/Al₂O₃; 0.40% | Pd/Al₂O₃; 0.60% |
| Volatility | | 1.9% | 1.9% |
| Exsudation | | 0% | 0% |
| Plastic viscosity | | 0.90 Pa · s at | 0.90 Pa · s at |
| | | 2344 Pa | 2344 Pa |
| H₂ pressure | at T = 0 h | 403 mmHg (0) | 402 mmHg (0) |
| in mmHg, | | | |
| H₂ absorption | at T = 48 h | 244 mmHg (2.59) | 173 mmHg (3.78) |
| in ml/g | | | |

TABLE 2c

| | | | DFP-free |
|---|---|---|---|
| Examples | | Ex. 12 | control |
| Catalyst/DFP ratio by | | 0.06% | 8 |
| weight | | | |
| Catalyst (% by weight) | | Pd/Al₂O₃; 0.30% | Pd/Al₂O₃; 0.60% |
| Volatility | | 1.43% | 1.17% |
| Exsudation | | 0% | 0% |
| Plastic viscosity | | 0.90 Pa · s at | 0.90 Pa · s at |
| | | 2344 Pa | 2344 Pa |
| H₂ pressure | at T = 0 h | 401 mmHg (0) | 405 mmHg (0) |
| in mmHg, | | | |
| H₂ absorption | at T = 48 h | 221 mmHg (2.97) | 321 mmHg (1.39) |
| in ml/g | | | |

The examples in Tables 3a to 3c are obtained from a model grease composed of:

10% by weight of vegetable oil (HLB 0.5),

3.8% by weight of a viscosifying polymer (Shellvis™ 40),

6.5% by weight of hydrophilic silica (Cab-O-Sil™ TS720),

0% to 0.3% of palladium supported on alumina catalyst,

q.s. for 100% of poly-alpha-olefin (PAO).

In all cases where the catalyst/DFP ratio by weight is greater than 0.01, the amounts of hydrogen absorbed in 48 h are greater than those absorbed by the control not comprising dispersing phase while comprising 0.6% of catalyst.

TABLE 3a

| Examples | | Control | Ex. 13 |
|---|---|---|---|
| Catalyst/DFP ratio by | | 0 | 0.01 |
| weight | | | |
| Catalyst (% by weight) | | 0% | Pd/Al₂O₃; 0.10% |
| Volatility | | 1.8% | 1.8% |
| Exsudation | | 0% | 0% |
| Plastic viscosity | | 0.87 Pa · s at | 0.89 Pa · s at |
| | | 2550 Pa | 2556 Pa |
| H₂ absorption | at T = 0 h | 0 | 0 |
| in ml/g | at T = 48 h | 0.05 | 0.98 |

TABLE 3b

| Examples | | Ex. 14 | Ex. 15 |
|---|---|---|---|
| Catalyst/DFP ratio by | | 0.02 | 0.03 |
| weight | | | |
| Catalyst (% by weight) | | Pd/Al₂O₃; 0.20% | Pd/Al₂O₃; 0.30% |
| Volatility | | 1.8% | 1.8% |
| Exsudation | | 0% | 0% |
| Plastic viscosity | | 0.88 Pa · s at | 0.87 Pa · s at |
| | | 2550 Pa | 2560 Pa |
| H₂ absorption | at T = 0 h | 0 | 0 |
| in ml/g | at T = 48 h | 1.9 | 2.3 |

TABLE 3c

| | | | DFP-free |
|---|---|---|---|
| Examples | | Ex. 16 | control |
| Catalyst/DFP ratio by | | 0.06% | 8 |
| weight | | | |
| Catalyst (% by weight) | | Pd/Al₂O₃; 0.60% | Pd/Al₂O₃; 0.60% |
| Volatility | | 1.8% | 1.17% |
| Exsudation | | 0% | 0% |
| Plastic viscosity | | 0.83 Pa · s at | 0.90 Pa · s at |
| | | 2394 Pa | 2344 Pa |
| H₂ absorption | at T = 0 h | 0 | 0 |
| in ml/g | at T = 48 h | 2 | 1.4 |

1. Composition, characterized in that it comprises a hydrocarbonaceous and/or silicone compound or a mixture of hydrocarbonaceous and/or silicone compounds, a nonzero proportion of one or more transition metals and a nonzero proportion of at least one slightly polar dispersing liquid fatty phase, having one or more hydrocarbonaceous chains, with an HLB of between 0.5 and 9, preferably between 4 and 9.

2. Composition as defined in claim 1, characterized in that the hydrocarbonaceous and/or silicone compound or mixture of hydrocarbonaceous and/or silicone compounds is chosen from hydrocarbons, hydrocarbonaceous polymers, silicone oils and/or polyol derivatives.

3. Composition as defined in either of claims 1 and 2, characterized in that it comprises from 50% to 90% by weight of hydrocarbonaceous and/or silicone compound or of mixture of hydrocarbonaceous and/or silicone compounds.

4. Composition as defined in one of claims 1 to 3, characterized in that the hydrocarbonaceous polymer is chosen from poly-alpha-olefins, polyisobutene, propylene-ethylene, propylene-butene and propylene-hexene copolymers, propylene-butene-ethylene terpolymers or polybutadienes.

5. Composition as defined in one of claims 1 to 4, characterized in that the silicone oils are chosen from poly(alkylsiloxanes) and in particular from poly(dimethylsiloxanes) with high molecular weights.

6. Composition as defined in one of claims 1 to 5, characterized in that the polyol derivatives are chosen from those obtained by etherification or esterification of a compound having several hydroxyl functional groups, such as, for example, glycerol, TMP or bisphenol, by means of hydrocarbonaceous fatty chains or alkoxide chains, such as polyethylene glycol, polypropylene glycol or polybutylene glycol.

7. The composition as defined in any one of claims 1 to 6, characterized in that it comprises one or more metal catalysts in a proportion by weight ranging up to 5% by weight.

8. Composition as defined in claim 7, characterized in that the metal catalyst is chosen from transition metals, organic salts of transition metals or organometallic compounds of the said metals.

9. Composition as defined in claim 8, characterized in that the metal catalyst is chosen from palladium powder, platinum powder, nickel powder, iron pentacarbonyl, chloroplatinic acid, copper chromite, Raney nickel, palladium supported on active charcoal, palladium supported on alumina, platinum supported on alumina or platinum supported on active charcoal.

10. Composition as defined in claim 9, characterized in that it comprises up to 1% by weight of palladium supported on alumina or on active charcoal.

11. Composition as defined in any one of claims 1 to 10, characterized in that it comprises up to 15% by weight of hydrophilic silica.

12. Composition as defined in any one of claims 1 to 8, characterized in that it comprises up to approximately 5% of a viscosifying polymer.

13. Composition as defined in any one of claims 1 to 12, characterized in that it comprises up to approximately 2% of an antioxidizing agent.

14. Composition as defined in any of one of claims 1 to 13, characterized in that the slightly polar dispersing liquid fatty phase, having one or more hydrocarbonaceous chains, with an HLB of between 0.5 and 9, preferably between 4 and 9, is liquid at ambient temperature.

15. Composition as defined in any one of claims 1 to 14, characterized in that it comprises from 1% to 20% and preferably between 5% and 10% by weight of dispersing fatty phase.

16. Composition as defined in any one of claims 1 to 15, characterized in that the ratio by weight of the metal catalyst or catalysts to the dispersing fatty phase in the composition is between approximately 0.01 and 0.20.

17. Composition as defined in any one of claims 1 to 16, characterized in that the dispersing fatty phase is chosen from vegetable oils.

18. Composition as defined in any one of claims 1 to 16, characterized in that the dispersing fatty phase is chosen from methyl esters of vegetable oils, monoglycerides or diglycerides obtained by controlled hydrolysis of vegetable oils, weakly alkoxylated vegetable oils, in particular weakly ethoxylated and/or propoxylated vegetable oils and more particularly ethoxylated vegetable oils comprising from 1 to 10 ethylene oxide units, or weakly alkoxylated methyl esters of vegetable oils, in particular weakly ethoxylated and/or propoxylated methyl esters of vegetable oils and more particularly methyl esters of vegetable oils ethoxylated with 1 to 4 ethylene oxides.

19. Composition as defined in either of claims 17 and 18, characterized in that the vegetable oil is chosen from sunflower oil, rapeseed oil, maize oil, soybean oil, castor oil, linseed oil, coconut oil, groundnut oil, olive oil, palm oil or hydrogenated palm oil.

20. Composition as defined in any one of claims 1 to 16, characterized in that the dispersing fatty phase is chosen from surface-active agents having an HLB number of between 1 and 9, preferably between 4 and 9, which are miscible with the oils which participate in the composition of the greases.

21. Composition as defined in claim 20, characterized in that the dispersing fatty phase is chosen from linear or branched fatty alcohols or fatty acids comprising from 5 to 30 carbon atoms and more particularly from 12 to 22 carbon atoms or esters of the said acids, the said alcohols, acids or esters optionally being weakly alkoxylated.

22. Composition as defined in claim 21, characterized in that the dispersing fatty phase is chosen from surface-active agents which are liquid at ambient temperature.

23. Composition as defined in claim 22, characterized in that the dispersing fatty phase is chosen from optionally weakly alkoxylated surface-active agents comprising an oleyl, oleyl/cetyl, linoleyl or behenyl chain.

24. Composition as defined in claim 23, characterized in that the dispersing fatty phase is chosen from sorbitan oleic esters, ethoxylated oleyl alcohols comprising from 1 to 5 ethylene oxide units, polyethylene glycol (PEG) oleates comprising from 1 to 5 ethylene oxide units, liquid glucose ethers or ethoxylated oleic acids comprising from 1 to 5 ethylene oxide units.

25. Process for producing the composition as defined in one of claims 1 to 24, characterized in that it comprises a stage of dispersing the catalyst in the dispersing agent, followed by mixing the dispersion in the other constituents of the composition.

26. Use of the composition as defined in one of claims 1 to 24 as composition for filling optical fiber cables.
